(19) United States
(12) Patent Application Publication
(10) Pub. No.: US 2025/0250967 A1
(43) Pub. Date: Aug. 7, 2025

(54) MODULAR NACELLE OF A WIND TURBINE HAVING A LIQUID SPILLAGE CONTAINMENT SYSTEM AND RELATED METHOD

(71) Applicant: Vestas Wind Systems A/S, Aarhus N. (DK)

(72) Inventors: Martin Patrick Vcelka, Gjern (DK); Gopi Vellore Babu, Chennai (IN)

(73) Assignee: Vestas Wind Systems A/S, Aarhus N (DK)

(21) Appl. No.: 18/855,819

(22) PCT Filed: Apr. 3, 2023
(86) PCT No.: PCT/DK2023/050090

§ 371 Date: Oct. 10, 2024

(30) Foreign Application Priority Data
Apr. 12, 2022 (IN) 20221102729
Jun. 1, 2022 (DK) PA 2022 70288

(51) Int. Cl. F03D 80/80

(52) U.S. Cl. CPC F03D 80/80

(57) ABSTRACT

A modular nacelle (16) of a wind turbine (10) includes a main nacelle unit (22), an auxiliary nacelle unit (24, 26) releasably connected to the main nacelle unit (22), the auxiliary nacelle unit (24, 26) having a wind turbine component (68) with a first liquid volume (VC,A), and a liquid containment system (100) for containing liquid spillage in the nacelle (16). The liquid containment system (100) includes a liquid spillage container (70) in the auxiliary nacelle unit (24, 26) and having a first container volume (VA), a liquid spillage container (50) in the main nacelle unit (22) and having a second container volume (VM), and a flow channel (102) providing fluid communication between the auxiliary liquid spillage container (70) and the main liquid spillage container (50) in response to liquid spillage in the auxiliary nacelle unit (24, 26) exceeding the first container volume (VA). A method of containing liquid spillage in a modular nacelle (16) is also disclosed.

### TECHNICAL FIELD

This invention relates generally to wind turbines, and more particularly to a modular nacelle of a wind turbine having an improved liquid containment system for large-volume liquid spillage, and to a method of containing large-volume liquid spillage in a modular nacelle.

### BACKGROUND

Wind turbines are used to produce electrical energy using a renewable resource and without combusting a fossil fuel. Generally, a wind turbine converts kinetic energy from the wind into electrical power. A horizontal-axis wind turbine includes a tower, a nacelle located at the apex of the tower, and a rotor having a plurality of blades and supported in the nacelle by means of a shaft. The shaft couples the rotor either directly or indirectly with a generator, which is housed inside the nacelle. Consequently, as wind forces the blades to rotate, electrical energy is produced by the generator. Wind turbines may be located either on a land mass (onshore) or within a body of water (offshore).

As electrical energy demands have increased over the past years, the size of wind turbines have also increased so that they may produce additional electrical energy. As the wind turbines increase in size, the physical dimensions and weight of the wind turbine components also increase. As the size and weight of the wind turbine components increase, transporting the wind turbine components from the manufacturing facility to the assembly site becomes increasingly challenging. To meet this challenge, the nacelle of the wind turbine may be constructed from one or more modules that contain one or more wind turbine components. The individual modules may be attached to one another during wind turbine installation to ultimately form the nacelle.

One must carefully consider how to arrange those modules so that the loads, in particular in the form of torque, do not require massive towers and yaw assemblies that are difficult and costly to manufacture, transport, and assemble. One approach is to arrange a main nacelle unit having a base plate around the yaw assembly and have auxiliary nacelle units attached to the sides of the main nacelle unit to collectively form the nacelle. The main nacelle unit and the auxiliary nacelle units may be pre-loaded with wind turbine components from the manufacturing facility or at the wind turbine installation site. The main nacelle unit and the auxiliary nacelle units carrying the wind turbine components may then be lifted and attached together at the top of the tower using, for example, a suitable crane.

The nacelle is provided with mechanical and electrical equipment needed to generate electrical power from the wind. In this regard, the main nacelle unit typically includes a gearbox and a generator, and the auxiliary nacelle units may include electric conversion equipment, such as transformers, converters, and the like. The wind turbine components in the main nacelle unit and the auxiliary nacelle units may contain a large amount of liquid that facilitates operation of the components during operation of the wind turbine. By way of example, the gearbox includes many moving parts and therefore includes a lubrication system with a significant volume of lubricant (e.g., lubrication oil). Further, the generator and main bearing housing may include liquid for cooling and/or lubrication purposes. Yet further, the transformer and converter also generate a large amount of heat and may include cooling systems with a liquid coolant. In particular, in the case of a “wet” transformer, in which the transformer is immersed in oil for electric insulation purposes, a significant volume of liquid may be present from the transformer alone, such as above 4,000 litres. In total, and depending on the size of the wind turbine, the nacelle may include several thousand litres (e.g., between 2,000-10,000 litres) of liquid in the various wind turbine components to facilitate operation of the wind turbine.

Over the operating life of the wind turbine, it is not uncommon for these wind turbine components to have small leaks such that there is some amount of liquid that is spilled or leaked outside of the wind turbine components. For example, over time seals may become worn and allow a small amount of liquid to leak from the wind turbine components. Many current wind turbines manage relatively small liquid spillage with one or more drip trays generally positioned beneath the individual components that catch or collect the relatively small-volume liquid spillage. The drip trays may be periodically monitored and, if necessary, emptied during routine scheduled maintenance of the wind turbine.

Although considered unlikely, there are some situations where wind turbine components may have a relatively large-volume or catastrophic leak scenario. These situations may arise, for example, during normal operation of the wind turbine or during repair procedures on the various wind turbine components. In these situations, the drip trays cannot handle the large volume of liquid from the catastrophic leak, and liquid generally spills throughout the nacelle. Significant liquid spillage has the potential to damage other wind turbine components in the nacelle, create a hazard for personnel working in the wind turbine, and create an environmental hazard if such liquid should leak outside the wind turbine. As to the latter point, many jurisdictions now include various regulations, laws, etc. that require reliable containment of liquid spillage to mitigate or prevent pollution to the surrounding environment.

Accordingly, what is needed is an improved liquid spillage containment system for a nacelle of a wind turbine, and a related method for containing liquid spillage, that is configured to accommodate large volumes of liquid spillage, such as on the order of several thousand liters of liquid. More particularly, what is needed is such an improved liquid spillage containment system and related method in the context of a modular nacelle of a wind turbine.

### SUMMARY

In a first aspect of the invention, a nacelle of a wind turbine having an improved liquid containment system is disclosed. The nacelle has a modular construction and includes a main nacelle unit having a main nacelle housing and at least one auxiliary nacelle unit releasably connected to the main nacelle unit. The at least one auxiliary nacelle unit includes an auxiliary nacelle housing with at least one first wind turbine component positioned in the auxiliary nacelle housing. The at least one first wind turbine component has a first component volume of liquid associated with the component. The nacelle further includes a liquid containment system for containing liquid spillage in the nacelle, and more particularly large-volume liquid spillage in the nacelle. The liquid containment system includes an auxiliary liquid spillage container associated with the at least one auxiliary nacelle unit and having a first container volume, a main liquid spillage container associated with the main nacelle unit and having a second container volume, and a flow channel extending between the auxiliary liquid spillage container and the main liquid spillage container. The flow channel is configured to provide fluid communication between the auxiliary liquid spillage container and the main liquid spillage container in response to liquid spillage in the at least one auxiliary nacelle unit exceeding the first container volume. Accordingly, while the auxiliary and main nacelle units are separate, self-contained units, the liquid containment system provides for liquid spillage to be transferred between the liquid spillage containers in the different nacelle units. This, in turn, allows the auxiliary nacelle units to remain compact while also providing effective liquid spillage management for the nacelle.

In one embodiment, the first component volume of liquid associated with the at least one first wind turbine component may be greater than the first container volume of the auxiliary liquid spillage container. For example, the first container volume may be less than about 50% of the first component volume, and preferably less than about 25% of the first component volume. Thus, the size of the auxiliary liquid spillage container may be relatively small so that most of the space in the at least one auxiliary nacelle unit may be taken up by wind turbine components and remain compact. However, the sum of the first container volume of the auxiliary liquid spillage container and the second container volume of the main liquid spillage container may be no less than the first component volume of liquid associated with the at least one first wind turbine component. In this way, should the at least one first wind turbine component have a catastrophic failure that causes large-volume liquid spillage in the at least one auxiliary nacelle unit, the liquid spillage will not overflow the auxiliary liquid spillage container but instead the excess liquid spillage will flow to the main liquid spillage container in the main nacelle unit. Accordingly, the large-volume liquid spillage will be contained in the collective liquid spillage containers and not spread to the rest of the nacelle or the external environment.

In one embodiment, the auxiliary liquid spillage container may be integrated into the auxiliary nacelle housing such that at least one wall of the auxiliary nacelle housing forms at least a portion of the auxiliary liquid spillage container. For example, the lower wall of the auxiliary nacelle housing may form at least a portion of the auxiliary liquid spillage container. This arrangement provides an efficient use of space within the auxiliary nacelle housing. In an alternative embodiment, however, the auxiliary liquid spillage container may be a separate container or tank located in the auxiliary nacelle housing, such as in a lower portion thereof.

In one embodiment, the flow channel may include a fluid conduit. The fluid conduit, in an exemplary embodiment, may include an auxiliary nacelle section positioned in the auxiliary nacelle housing and in fluid communication with the auxiliary liquid spillage container, a main nacelle section positioned in the main nacelle housing and in fluid communication with the main liquid spillage container, and an intermediate conduit section positioned between the auxiliary nacelle section and the main nacelle section and selectively connectable to the auxiliary nacelle section and the main nacelle section. In one embodiment, the auxiliary nacelle section of the fluid conduit may include an inlet that, at least in part, determines the first container volume of the auxiliary liquid spillage container. In one embodiment, the intermediate conduit section may include a sleeve selectively connectable to the auxiliary nacelle section and the main nacelle section. In yet another embodiment, the auxiliary liquid spillage container may be at a greater vertical height than the main liquid spillage container such that fluid communication therebetween is unidirectional (i.e., from the auxiliary liquid spillage container to the main liquid spillage container) and due to gravity. Thus, fluid communication between the two liquid spillage containers may be achieved without powered equipment, such as pumps. In an alternative embodiment, however, the liquid containment system may further include one or more pumps to provide fluid communication from the auxiliary liquid spillage container to the main liquid spillage container.

In one embodiment, the at least one first wind turbine component positioned in the auxiliary nacelle housing of the at least one auxiliary nacelle unit may include a transformer, which is associated with a large volume of liquid. In one embodiment, the main nacelle housing may include at least one second wind turbine component positioned in the main nacelle housing and have a second component volume of liquid associated with the component. In one embodiment, the at least one second wind turbine component positioned in the main nacelle housing of the main nacelle unit may include at least one of a gearbox and a generator. In one embodiment, the second container volume of the main liquid spillage container may be no less than the sum of the second component volume of the at least one second wind turbine component and the difference between the first component volume and the first container volume of the auxiliary liquid spillage container.

In another aspect of the invention, a wind turbine is disclosed having a tower and the modular nacelle having the improved liquid containment system according to the first aspect described above mounted to the tower.

In still a further aspect of the invention, a method of containing liquid spillage in a nacelle of a wind turbine, and more particularly a method of containing large-volume liquid spillage in a modular nacelle is disclosed. The nacelle includes a main nacelle unit and at least one auxiliary nacelle unit releasably connected to the main nacelle unit. The at least one auxiliary nacelle unit includes an auxiliary nacelle housing having at least one first wind turbine component positioned in the auxiliary nacelle housing and having a first component volume of liquid associated with the component. The method includes directing liquid spillage from the at least one first wind turbine component in the auxiliary nacelle housing to an auxiliary liquid spillage container associated with the at least one auxiliary nacelle unit, the auxiliary liquid spillage container having a first container volume; and in response to the liquid spillage from the at least one wind turbine component exceeding the first container volume of the auxiliary liquid spillage container, directing liquid spillage from the auxiliary liquid spillage container to a main liquid spillage container associated with the main nacelle unit.

In one embodiment, directing liquid spillage from the auxiliary liquid spillage container to the main liquid spillage container further includes directing liquid spillage through a flow channel, such as a fluid conduit, that extends between and in fluid communication with the auxiliary liquid spillage container and the main liquid spillage container. By way of example, in one embodiment, directing liquid spillage from the auxiliary liquid spillage container to the main liquid spillage container further includes using gravity to transport liquid spillage from the auxiliary liquid spillage container to the main liquid spillage container. Thus, the management of liquid spillage in the nacelle may be achieved without the use of pumps or other powered devices. Alternatively, one or more pumps may be provided to transport liquid spillage from the auxiliary liquid spillage container to the main liquid spillage container.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a wind turbine having a nacelle including a main nacelle unit and two auxiliary nacelle units attached to the side of the main nacelle unit;

FIG. 2 is a partial cross-section view of the main nacelle unit and the two auxiliary nacelle units in FIG. 1;

FIG. 3 is a torn away partial perspective view of one of the auxiliary nacelle units illustrating a liquid containment system in accordance with an embodiment of the invention; and

FIG. 4 is partial side cross-sectional view of the auxiliary nacelle unit illustrating the liquid containment system.

### DETAILED DESCRIPTION

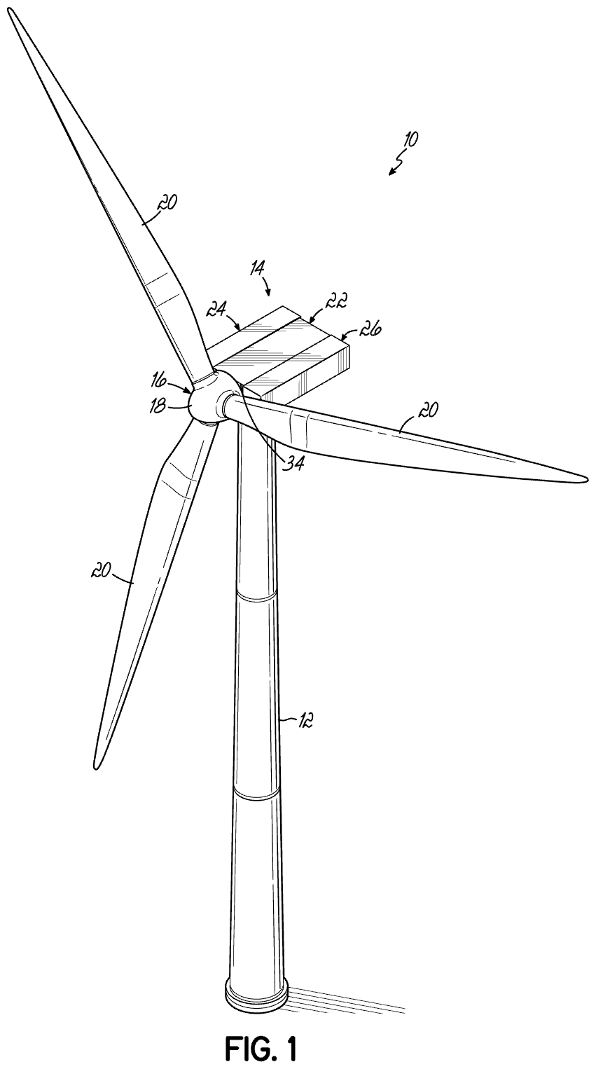

Referring to FIG. 1, a wind turbine 10 includes a tower 12, a nacelle 14 disposed at the apex of the tower 12, and a rotor 16 operatively coupled to a generator (not shown) housed inside the nacelle, and a gearbox (not shown) also housed inside the nacelle 14. In addition to the generator and gearbox, the nacelle 14 may house various components needed to convert wind energy into electrical energy and to operate and optimize the performance of the wind turbine 10. The tower 12 supports the load presented by the nacelle 14, rotor 16, and other wind turbine components housed inside the nacelle 14 and operates to elevate the nacelle 14 and rotor 16 to a height above ground level or sea level, as may be the case, at which air currents having lower turbulence and higher velocity are typically found.

The rotor 16 may include a central hub 18 and a plurality of blades 20 attached to the central hub 18 at locations distributed about the circumference of the central hub 18. In the representative embodiment, the rotor 16 includes three blades 20, however the number may vary. The blades 20, which project radially outward from the central hub 18, are configured to interact with passing air currents to produce rotational forces that cause the central hub 18 to spin about its longitudinal axis. The design, construction, and operation of the blades 20 are familiar to a person having ordinary skill in the art of wind turbine design and may include additional functional aspects to optimize performance. For example, pitch angle control of the blades 20 may be implemented by a pitch control mechanism (not shown) responsive to wind velocity to optimize power production in low wind conditions, and to feather the blades if wind velocity exceeds design limitations.

The rotor 16 may be coupled to the gearbox directly or indirectly via by a drive shaft (not shown). Either way, the gearbox transfers the rotation of the rotor 16 through a coupling (not shown) to the generator. Wind exceeding a minimum speed may activate the rotor 16, causing the rotor 16 to rotate in a direction substantially perpendicular to the wind, applying torque to the input shaft of the generator. The electrical power produced by the generator may be supplied to a power grid (not shown) or an energy storage system (not shown) for later release to the grid as understood by a person having ordinary skill in the art. In this way, the kinetic energy of the wind may be harnessed by the wind turbine 10 for power generation.

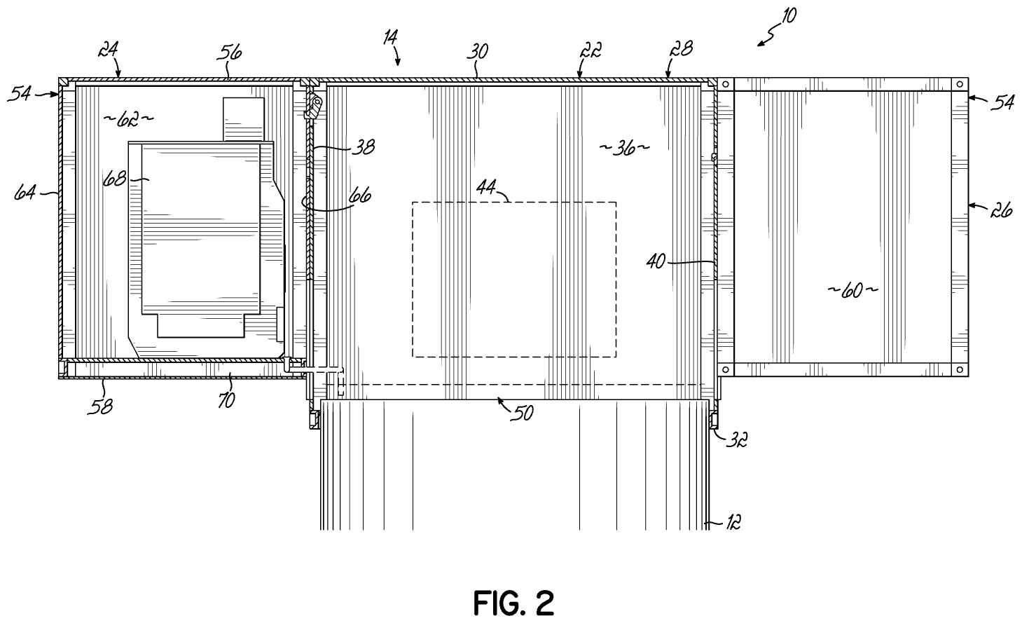

Referring to FIGS. 1 and 2, in an exemplary embodiment the nacelle 14 may have a modular configuration and be formed from a main nacelle unit 22 and at least two auxiliary nacelle units 24, 26, which are removably connected to the opposing sides of the main nacelle unit 22. The main nacelle unit 22 and auxiliary nacelle units 24, 36 are distinct, self-contained units that may be shipped to a wind turbine installation site separately and then assembled to form the nacelle 14. In one embodiment, for example, the main nacelle unit 22 may be hoisted up and placed at the apex of the tower 12 using, for example, a large crane or the like. The auxiliary nacelle units 24, 26 may then be hoisted one at a time and attached to opposite sides of the main nacelle unit 22 to form the nacelle 14. In an alternative embodiment, one or both auxiliary nacelle units 24, 26 may be connected to the main nacelle unit 22 on the ground, deck of a ship, assembly site, etc., and then that assembly hoisted to the top of the tower 12.

Referring to FIG. 2, in one embodiment, the main nacelle unit 22 may include a generally rectangular main housing 28 with an upper wall 30, a lower wall 32, a front wall 34 (e.g., toward the rotor 16), a rear wall 36 (opposite the rotor 16), and opposing side walls 38, 40. The main nacelle unit 22 is configured to be positioned over the upper end of the tower 12 and connected to the tower 12 via a yaw assembly (not shown), as is generally known in the wind turbine industry. The main nacelle unit 22 includes a base frame (not shown) that supports several wind turbine components within the main nacelle housing 28, including the main bearing housing, the main shaft, the gearbox, and the generator. One or more wind turbine components, schematically denoted in FIG. 2 by reference number 44, in the main nacelle housing 28 may include a volume of liquid V_{C,M} for its operation. The one or more wind turbine components 44 may include the gearbox, generator, and/or other liquid-containing components. For example, as noted above, the gearbox includes a lubrication system having a large volume of lubricant that facilitates operation of the gearbox. Similarly, the generator may include a cooling system having some volume of coolant. Furthermore, the main nacelle unit 22 may include a hydraulic circuit (e.g., hydraulic accumulators) having a large volume of hydraulic fluid for operating the pitch mechanisms in the hub 18 of the rotor 16. In any event, it should be appreciated that the main nacelle unit 22 may include at least one wind turbine component 44 having a volume of liquid V_{C,M} and susceptible to liquid spillage, and more particularly to large-volume liquid spillage in the main nacelle housing 28.

Thus, in accordance with an embodiment of the invention, the main nacelle unit 22 may include a liquid spillage container 50, e.g., shown schematically in FIG. 2, configured to hold a volume V_{M} of spilled liquid in the main nacelle housing 28 of the main nacelle unit 22. In one embodiment, the liquid spillage container 50 may be positioned in a lower portion of the main nacelle housing 28. In this way, liquid spillage (e.g., large-volume liquid spillage) from the at least one wind turbine component 44 in the main nacelle unit 22 may flow toward and be collected in the liquid spillage container 50 through gravity. Since the nacelle 14 has a self-contained modular configuration, in one embodiment, the liquid spillage container 50 may be integrated into the main nacelle housing 28 such that the liquid spillage container 50 may be formed from one or more of the walls of the main nacelle housing 28. For example, at least a portion of the lower wall 32 of the main nacelle housing 28 may form a portion of the liquid spillage container 50. In this embodiment, the main nacelle housing 28 may include a raised floor and the liquid spillage container 50 may be disposed between the raised floor and the lower wall 32 of the main nacelle housing 28. Alternatively, the liquid spillage container 50 may be formed by a separate container or tank that is disposed in the lower portion of the main nacelle housing 48 but arranged such that liquid spilled from the at least one wind turbine component 44 in the main nacelle unit 22 may flow toward and be collected in the liquid spillage container 50.

As the main nacelle unit 22 is relatively large, the volume V_{M} of the liquid spillage container 50 may likewise be relatively large. In one embodiment, the volume of the liquid spillage container 50 may be no less than, and preferably greater than, the volume of liquid contained in all of the wind turbine components 44 located in the main nacelle housing 28. For example, in one embodiment, the volume V_{M} of the liquid spillage container 50 may be no less than, and preferably greater than, the sum of the liquid volume associated with the gearbox V_{gbox} and the liquid volume associated with generator V_{gen}, i.e., V_{M}≥V_{gbox}+V_{gen}. However, because it is unlikely that multiple wind turbine components 44 in the main nacelle unit 22 will have a catastrophic failure resulting in a large-volume spillage at the same time, in another embodiment, the volume V_{M} of the liquid spillage container 50 may be no less than the maximum volume of liquid in any one of the multiple wind turbine components 44 located in the main nacelle housing 28. Accordingly, should any one of the wind turbine components 44 in the main nacelle unit 22 catastrophically fail or otherwise be subject to a large-volume leak, the liquid spillage container 50 will be able to contain the spillage and prevent the spillage from escaping from the main nacelle unit 22.

Turning now to the auxiliary nacelle units 24, 26, in one embodiment, each of the auxiliary nacelle units 24, 26 may be generally smaller than the main nacelle unit 22 and may include a generally rectangular auxiliary housing 54 with an upper wall 56, a lower wall 58, a front wall 60 (e.g., toward the rotor 16), a rear wall 62 (opposite the rotor 16), and opposing side walls 64, 66. The auxiliary nacelle units 24, 26 are configured to be releasably connected to opposed side walls 38, 40 of the main nacelle unit 22, respectively. The manner in which the auxiliary nacelle units 24, 26 are connected to the main nacelle unit 22 is generally known to those of ordinary skill in the art and thus will not be described in further detail herein. At least one of auxiliary nacelle units 24, 26 may support several wind turbine components within their respective housings 54, including the various electrical components such as a transformer, a converter, or switch gear. One or more wind turbine components in the auxiliary nacelle housing 54, schematically denoted in FIG. 2 by reference number 68, may include a volume of liquid V_{C,A} for its operation. The one or more wind turbine components 68 may include the transformer or other liquid-containing component. For example, the transformer may be immersed in oil for electrical insulation, thereby having a large volume of liquid contained therein. The at least one of the auxiliary nacelle units 24, 26 may include other wind turbine components 68 susceptible to liquid spillage and should not be limited to the transformer. Thus, it should be appreciated that at least one of the auxiliary nacelle units 24, 26 may include at least one wind turbine component 68 having a volume of liquid V_{C,A} and susceptible to liquid spillage, and more particularly to large-volume liquid spillage in the auxiliary nacelle housing 54.

Similar to the above, and in accordance with an embodiment of the invention, the at least one of the auxiliary nacelle units 24, 26 may include a liquid spillage container 70, shown schematically in FIG. 2, configured to hold a volume V_{A} of spilled liquid in the auxiliary nacelle housing 54 of the at least one of the auxiliary nacelle units 24, 26. In one embodiment, the liquid spillage container 70 may be positioned in a lower portion of the auxiliary nacelle housing 54. In this way, liquid spillage (e.g., large-volume liquid spillage) from the at least one wind turbine component 68 in the at least one of the auxiliary nacelle units 24, 26 may be collected in the liquid spillage container 70 through gravity. This may be further advantageous in that should there be a leak (e.g., high pressure leak) from a pipe, conduit, coupling or the like, the liquid spray will contact a wall or other surface and eventually flow to and be collected in the drip trays or the liquid spillage container 70.

Since the nacelle 14 has a self-contained modular configuration, in one embodiment, the liquid spillage container 70 may be integrated into the auxiliary nacelle housing 54 such that the liquid spillage container 70 may be formed from one or more of the walls of the auxiliary nacelle housing 54. For example, at least a portion of the lower wall 58 of the auxiliary housing 54 may form a portion of the liquid spillage container 70. In this embodiment, the auxiliary nacelle housing 54 may include a raised floor and the liquid spillage container 70 may be disposed between the raised floor and the lower wall 58 of the auxiliary nacelle housing 54. Alternatively, the liquid spillage container 70 may be a separate container or tank that is disposed in the lower portion of the auxiliary nacelle housing 54 but arranged such that liquid spilled from the at least one wind turbine component 68 in the at least one of the auxiliary nacelle units 24, 26 may flow toward and be collected in the liquid spillage container 70.

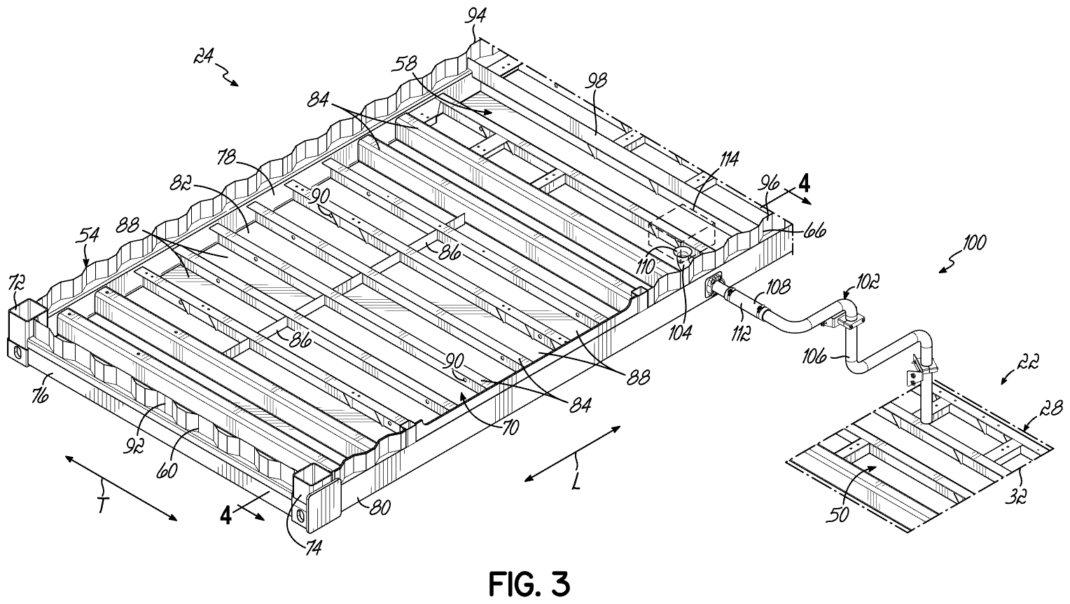

FIG. 3 illustrates the auxiliary nacelle housing 54 of the auxiliary nacelle unit 24 having the liquid spillage container 70 integrated into the auxiliary nacelle housing 54 in accordance with an embodiment of the invention. More particularly, the lower wall 58 of the auxiliary nacelle housing 54 forms a substantial portion of the liquid spillage container 70. In this regard, the lower wall 58 includes a first pair of corner posts 72, 74, a front rail 76 extending between the corner posts 72, 74 in a first transverse direction T, a pair of side rails 78, 80 extending between the first corner posts 72, 74 and a second pair of corner posts (now shown) in a second longitudinal direction L, and a lower panel 82 attached to a lower surface of rails 76, 78. The lower wall 58 may further include a plurality of transverse support struts 84 extending between the side rails 78, 80 in spaced apart relation, and a plurality of longitudinal support struts 86 extending between adjacent transverse support struts 82. The configuration of the lower wall 58 defines a plurality of compartments 88 for defining at least a part the liquid spillage container 70. In one embodiment, the transverse and/or longitudinal support struts 82, 84 may include one or more openings 90 that allow one or more of the plurality of compartments 88 to be in fluid communication with each other. In this way, the plurality of compartments 88 are permitted to fill up in a parallel manner during, for example, a catastrophic failure when a large amount of liquid is being directed to the liquid spillage container 70.

In an alternative embodiment, the transverse and/or longitudinal support struts 82, 84 may be devoid of openings such that the plurality of compartments 88 fill up in a serial manner when the liquid from one compartment 88 overflows its boundaries (e.g., upper edge of struts 82, 84) and starts to spill into an adjacent compartment 88. In yet another embodiment, some of the transverse and/or longitudinal struts 82, 84 may include one or more openings 90 such that some of the plurality of compartments 88 fill in a parallel manner and some of the plurality of compartments 88 fill in a serial manner. Thus, embodiments of the invention should not be limited by the particular way in which the compartments 88 that define, at least in part, the liquid spillage container 70 are filled due to a large-volume liquid spillage.

In one embodiment, the liquid spillage container 70 may extend above the front rail 76, side rails 78, 80, and the transverse and/or longitudinal support struts 84, 86 of the lower wall 58. In this embodiment, the front wall 60 may include a front panel 92 extending upwardly from the front rail 76, and the side walls 64, 66 may similarly include side panels 94, 96 extending upwardly from the side rails 78, 80. The liquid spillage container 70 may be bounded by at least the lower portions of the front panel 92 and the side panels 94, 96. However, the lower wall 58 may further include a dam 98 that provides a boundary to the liquid spillage container 70 along at least one side thereof. The components that collectively form the liquid spillage container 70 are assembled in a manner such that the liquid spillage container 70 integrated into the auxiliary nacelle housing 54 is substantially liquid tight.

In modular nacelle constructions, space inside the at least one of the auxiliary nacelle units 24, 26 may be severely limited. Accordingly, it is undesirable for the liquid spillage container 70 in the at least one of the auxiliary nacelle units 24, 26 to be relatively large. More particularly, in order to fit all the desired wind turbine components 68 in the at least one of the auxiliary nacelle units 24, 26, the volume V_{A} of the liquid spillage container 70 may be configured to be relatively small, and generally less than the liquid volume V_{C,A} associated with the at least one wind turbine component 68 in the auxiliary nacelle housing 54. For example, in one embodiment, the volume V_{A} of the liquid spillage container 70 may be less than 50% of the volume V_{C,A} associated with the at least one wind turbine component 68, and preferably, the volume V_{A} of the liquid spillage container 70 may be less than 25% of volume V_{C,A} associated with the at least one wind turbine component 68. For example, the at least one wind turbine component 68 may include the transformer, which may have between 4,000-8,000 liters of liquid associated with it. Thus, if the transformer has a catastrophic failure, the liquid spillage container 70 will not be able to contain all of the liquid in the transformer and liquid will flow outside of the liquid spillage container 70 into the auxiliary nacelle housing 54, and possibly outside of the auxiliary housing 54 to the environment.

To address this possibility, and in accordance with an embodiment of the invention, the modular nacelle 14 includes a liquid containment system 100 that manages large-volume liquid spillage in a way that prevents the liquid spillage in excess of the volume V_{A} of the liquid spillage container 70 in the at least one of the auxiliary nacelle units 24, 26 from polluting the auxiliary nacelle housing 54 or the environment external to the auxiliary nacelle housings 54. In an exemplary embodiment, the liquid containment system 100 includes the liquid spillage container 70 in the at least one of the auxiliary nacelle units 24, 26, the liquid spillage container 50 in the main nacelle unit 22, and a flow channel 102 extending between the two liquid spillage containers 70, 50 and which provides fluid communication between the two liquid spillage containers 70, 50. In this way, should the at least one wind turbine component 68 in the at least one of the auxiliary nacelle units 24, 26 have a catastrophic failure or other large-volume leak, the liquid spillage will start to fill up the liquid spillage container 70 in the at least one of the auxiliary nacelle unit 24, 26. When the liquid spillage collected in the liquid spillage container 70 reaches its maximum volume V_{A}, further liquid spillage causes liquid to flow through the flow channel 102 from the liquid spillage container 70 and into the liquid spillage container 50 in the main nacelle unit 22. In this embodiment, while the volume V_{A} of the liquid spillage container 70 may be less than the liquid volume V_{C,A} of the at least one of wind turbine component 68, the sum of the volume V_{A} of the liquid spillage container 70 and the volume V_{M} of the liquid spillage container 50 in the main nacelle unit 22 is configured to be greater than or equal to the liquid volume V_{C,A} of the at least one wind turbine component 68, i.e., V_{A}+V_{M}≥V_{C,A}. Thus, should the at least one wind turbine component 68 have a catastrophic failure, none of the liquid will escape from the liquid spillage containers 50, 70 provided by the nacelle 14 and leak into the housings 28, 54 or into the environment.

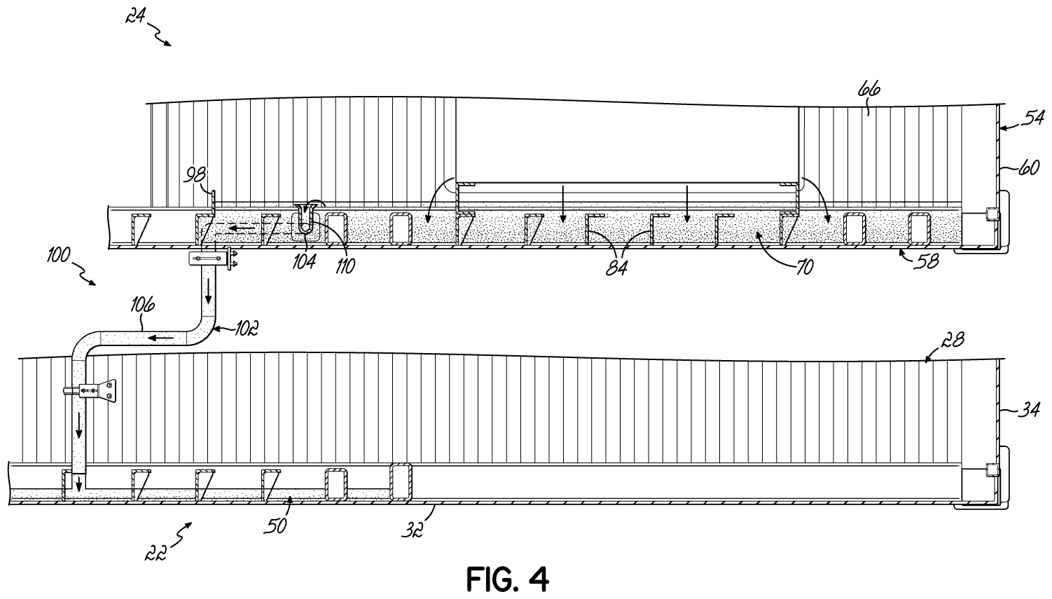

The flow channel 102 may be any passageway that provides fluid communication between the two liquid spillage containers 70, 50. For example, the flow channel 102 may be an open channel passageway or a closed channel passageway. In one embodiment, the flow channel may include one or more fluid conduits. As illustrated in FIGS. 3 and 4, in an exemplary embodiment, the fluid conduit 102 may include an auxiliary nacelle unit section 104 associated with the auxiliary nacelle unit 24, 26, a main nacelle unit section 106 associated with the main nacelle unit 22, and an intermediate connector section 108 that connects the two sections 104, 106 together. The auxiliary nacelle unit section 104 may include an inlet 110 positioned within the auxiliary liquid spillage container 70 and at some distance above the lowermost part of the container 70 (e.g., such as some distance above the lower panel 82. In this way, the inlet 110 of the auxiliary nacelle unit section 104 defines, at least in part, the volume VA of the auxiliary liquid spillage tank 70. In one embodiment, the intermediate connector section 108 may include a sleeve 112 that fits over respective ends of the auxiliary and main nacelle unit section 104, 106 and secured thereto using, for example, band clamps or other connectors. In this way, the intermediate connector section 108 may be installed after the at least one of the auxiliary nacelle units 24, 26 and the main nacelle unit 22 are connected together.

In an exemplary embodiment, the flow of liquid spillage from the auxiliary liquid spillage container 70 to the main liquid spillage container 50 may be a due to gravity (i.e., hydrostatic pressure). In this regard, the auxiliary liquid spillage container 70 may be positioned vertically above the main liquid spillage container 50. In this way, fluid communication between the two spillage containers 70, 50 occurs in only one direction, i.e., from the auxiliary liquid spillage container 70 to the main liquid spillage container 50, and as a result of gravity. Thus, the liquid containment system 100 does not need any powered equipment, such as pumps or the like, to facilitate the liquid flow from the auxiliary liquid spillage container 70 to the main liquid spillage container 50.

While the liquid containment system 100 described above is configured to operate under gravity and thereby avoid the use of powered equipment, such as pumps or the like, aspects of the invention are not limited to such gravity-based systems. In this regard, and in an alternative embodiment, the liquid containment system 100 may include one or more pumps 114, shown schematically in FIG. 3, in fluid communication with the auxiliary liquid spillage container 70 for providing the transport of liquid from the auxiliary liquid spillage container 70 to the main liquid spillage container 50. For example, in one embodiment, the auxiliary spillage container 70 may be positioned vertically below the main liquid spillage container 50. In this embodiment, the one or more pumps 114 provide the pressure for transporting liquid in the auxiliary spillage container 70 to the main liquid spillage container 50 through the flow channel 102. One or more valves, such as check valves (not shown) may be provided to prevent the back flow of liquid from the main liquid spillage container 50 back to the auxiliary liquid spillage container 70.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A nacelle of a wind turbine, comprising:
a main nacelle unit including a main nacelle housing;
at least one auxiliary nacelle unit releasably connected to the main nacelle unit and including an auxiliary nacelle housing with at least one first wind turbine component positioned in the auxiliary nacelle housing and having a first component volume (V_{C,A}) of liquid associated therewith; and
a liquid containment system for containing liquid spillage in the nacelle, comprising:
an auxiliary liquid spillage container associated with the at least one auxiliary nacelle unit and having a first container volume (V_{A});
a main liquid spillage container associated with the main nacelle unit and having a second container volume (V_{M}); and
a flow channel extending between the auxiliary liquid spillage container and the main liquid spillage container, the flow channel configured to provide fluid communication between the auxiliary liquid spillage container and the main liquid spillage container in response to liquid spillage in the at least one auxiliary nacelle unit exceeding the first container volume (V_{A}).

2. The nacelle of claim 1, wherein the first component volume (V_{C,A}) of liquid associated with the at least one first wind turbine component is greater than the first container volume (V_{A}) of the auxiliary liquid spillage container.

3. The nacelle of claim 2, wherein the first container volume (V_{A}) is less than about 50% of the first component volume (V_{C,A}), and preferably less than about 25% of the first component volume (V_{C,A}).

4. The nacelle of claim 1, wherein the sum of the first container volume (V_{A}) of the auxiliary liquid spillage container and the second container volume (V_{M}) of the main liquid spillage container is no less than the first component volume (V_{C,A}) associated with the at least one first wind turbine component.

5. The nacelle of claim 1, wherein the auxiliary liquid spillage container is integrated into the auxiliary nacelle housing such that at least one wall of the auxiliary nacelle housing forms at least a portion of the auxiliary liquid spillage container.

6. The nacelle of claim 5, wherein the lower wall of the auxiliary nacelle housing forms at least a portion of the auxiliary liquid spillage container.

7. The nacelle of claim 1, wherein the flow channel includes a fluid conduit, the fluid conduit comprising:
an auxiliary nacelle section positioned in the auxiliary nacelle housing and in fluid communication with the auxiliary liquid spillage container;
a main nacelle section positioned in the main nacelle housing and in fluid communication with the main liquid spillage container; and
an intermediate conduit section positioned between the auxiliary nacelle section and the main nacelle section and selectively connectable to the auxiliary nacelle section and the main nacelle section.

8. The nacelle of claim 7, wherein the auxiliary nacelle section includes an inlet that determines, at least one part, the first container volume (V_{A}) of the auxiliary liquid spillage container.

9. The nacelle of claim 1, wherein the auxiliary liquid spillage container is at a greater vertical height than the main liquid spillage container such that fluid communication therebetween is unidirectional and due to gravity.

10. The nacelle of claim 1, wherein the liquid containment system further comprises a pump to facilitate communication between the auxiliary liquid spillage container and the main liquid spillage container.

11. The nacelle of claim 1, wherein the at least one first wind turbine component positioned in the auxiliary nacelle housing of the at least one auxiliary nacelle unit includes a transformer.

12. The nacelle of claim 1 any of the preceding claims, wherein the main nacelle housing of the main nacelle unit includes at least one second wind turbine component positioned in the main nacelle housing and having a second component volume (V_{C,M}) of liquid associated therewith.

13. The nacelle of claim 12, wherein the at least one second wind turbine component positioned in the main nacelle housing of the main nacelle unit includes at least one of a gearbox and a generator.

14. A wind turbine comprising:
a tower; and
the nacelle of claim 1 mounted to the tower.

15. A method of containing liquid spillage in a nacelle of a wind turbine, the nacelle comprising a main nacelle unit and at least one auxiliary nacelle unit releasably connected to the main nacelle unit, the at least one auxiliary nacelle unit including an auxiliary nacelle housing having at least one first wind turbine component positioned in the auxiliary housing and having a first component volume (V_{C,A}) of liquid associated therewith, the method comprising
directing liquid spillage from the at least one first wind turbine component in the auxiliary nacelle housing to an auxiliary liquid spillage container associated with the at least one auxiliary nacelle unit, the auxiliary liquid spillage container having a first container volume (V_{A}); and
in response to the liquid spillage from the at least one first wind turbine component exceeding the first container volume (V_{A}) of the auxiliary liquid spillage container, directing liquid spillage from the auxiliary liquid spillage container associated with the at least one auxiliary nacelle unit to a main liquid spillage container associated with the main nacelle unit.

16. The method of claim 15, wherein directing liquid spillage from the auxiliary liquid spillage container to the main liquid spillage container further comprises directing liquid spillage through a flow channel that extends between and in fluid communication with the auxiliary liquid spillage container and the main liquid spillage container.

17. The method of claim 15, wherein directing liquid spillage from the auxiliary liquid spillage container to the main liquid spillage container further comprises using gravity to transport liquid spillage from the auxiliary liquid spillage container to the main liquid spillage container.

18. The method of claim 15, wherein directing liquid spillage from the auxiliary liquid spillage container to the main liquid spillage container further comprises using a pump to transport liquid spillage from the auxiliary liquid spillage container to the main liquid spillage container.
